(19) United States
(12) Patent Application Publication
(10) Pub. No.: US 2023/0082874 A1
(43) Pub. Date: Mar. 16, 2023

(54) FILLER STRUCTURE RETENTION INPOLYMERIC COMPOSITIONS

(71) Applicant: BIRLA CARBON U.S.A., INC., Marietta, GA (US)

(72) Inventor: Jun Tian, Marietta, GA (US)

(21) Appl. No.: 17/801,051

(22) PCT Filed: Feb. 22, 2021
(86) PCT No.: PCT/US2021/019066

§ 371 Date: Aug. 19, 2022

Related U.S. Application Data
(60) Provisional application No. 62/979,335, filed on Feb. 20, 2020.

(51) Int. Cl. C08J 3/20; C08K 3/04

(52) U.S. Cl. CPC C08J 3/203; C08K 3/04; C08K 2201/001; C08K 2201/005; C08K 2201/006; C08J 2300/12; C08J 2300/22

(57) ABSTRACT

Polymer compositions comprising high structure filler materials and methods for preparing such compositions while retaining structure.

### CROSS-REFERENCE TO RELATED APPLICATIONS

This application claims the benefit of U.S. Provisional Application No. 62/979,335, filed Feb. 20, 2020, which is incorporated by reference in its entirety.

### BACKGROUND

### Technical Field

The present disclosure relates to polymeric compositions comprising a filler, methods of compounding such filler containing polymeric compositions to retain the structure of the filler, and specifically such polymeric compositions wherein the filler comprises a high structure carbon black.

### Technical Background

Fillers, such as carbon black, can be utilized in a variety of applications to impart desirable properties to polymeric materials. In various aspects, such fillers can provide resistance to ultraviolet radiation, electrical and/or thermal conductivity, reinforcement, and/or color.

The conductivity of a polymer comprising a filler such as carbon black can be related to the structure of the filler. While high structure fillers such as carbon blacks can be produced, this high structure is usually reduced or broken-down when the filler is compounded into the polymeric system. Thus, there is a need for improved high structure filler containing polymeric materials and methods for produced the same. These needs and other needs are satisfied by the compositions and methods of the present disclosure.

### SUMMARY

In accordance with the purpose(s) of the invention, as embodied and broadly described herein, this disclosure, in one aspect, relates to polymeric compositions comprising a filler, methods of compounding such filler containing polymeric compositions to retain the structure of the filler, and specifically such polymeric compositions wherein the filler comprises a high structure carbon black.

In one aspect, disclosed is a process for preparing a polymer compound, comprising: (a) providing a feed composition comprising a polymer and a filler; wherein the filler is present in the feed composition in an amount ranging from 5% to 40% by weight of the feed composition; and (b) homogenizing the feed composition to form a molten polymer composition; wherein homogenizing is carried out at a temperature that is 10° C. to 100° C. higher than the upper limit of the recommended processing temperature range of the polymer; thereby forming the polymer compound.

Also disclosed are polymer compounds prepared according to a disclosed method.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawing, which is incorporated in and constitutes a part of this specification and together with the description, serves to explain the principles of the disclosure.

FIG. 1 is a diagram depicting an exemplary design of two counter-rotating, non-intermeshing screws (style 7/15, or #7/#15, rotor combination) in a single-stage Farrel Continuous Mixer along with relevant functional zones (Feed Section, Mixing Section, Apex Region).

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications (including ASTM methods) mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

As used herein, “melt flow index” is a measure of how many grams of a polymer flow through a die in ten minutes and thus is represented by the unit “g/10 min.” The test for measuring melt flow index is performed at a given temperature depending on the polymer. The test method is described in more detail under American Society for Testing and Materials (ASTM) D1238, which is incorporated by reference in its entirety.

As used herein, “recommended processing temperature” refers to a temperature range specified by the manufacturer of a polymer (usually listed in a technical data sheet), or determined using methods known in the art, at which the polymer should be processed to avoid degradation of the polymer. Thus, for example, if a particular polypropylene has a recommended processing temperature range of 180° C. to 230° C., the polypropylene can the processed according to the methods described herein at a temperature of from 10° C. to 100° C. higher than the upper limit of the recommended processing temperature range, i.e., from 240° C. to 330° C.

An “aciniform structure,” as used herein, refers to carbon black which is composed of spheroidal carbon particles fused together in aggregates of colloidal dimensions (also known as aciniform carbon or “AC”), visible under transmission electron microscopy (TEM) as a clustered grape-like structure.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, the present disclosure provides polymeric compositions comprising a filler, methods of compounding such filler containing polymeric compositions to retain the structure of the filler, and specifically such polymeric compositions wherein the filler comprises a high structure carbon black.

Morphological characteristics of carbon black include, for example, particle size/fineness, surface area, aggregate size/structure, aggregate size distribution, and aggregate shape. Particle size is a measurement of diameter of the primary particles of carbon black. These roughly spherical particles of carbon black have an average diameter in the nanometers range. Particle size can be measured directly via electron microscopy or indirectly by surface area measurement. Average particle size is an important factor that can determine the dispersibility, tensile strength, tear resistance, hysteresis, and abrasion resistance in a rubber article while in liquids and plastics systems, the average particle size can strongly influence the relative color strength, UV stability, and conductivity of the composite. At equal structure, smaller particle size imparts higher tensile strength, tear resistance, hysteresis and abrasion resistance, stronger color, UV resistance, and increased difficulty of dispersion.

Carbon black particles coalesce to form larger clusters or aggregates, which are the primary dispersible units of carbon black. Aggregate size and structure are controlled in the reactor. Measurement of aggregate structure can be obtained from electron microscopy or oil absorption. Structure was historically measured by N-dibutyl phthalate, or DBP, absorption, now replaced by oil absorption number, or OAN (ASTM D2414-18, ISO 4656/1). Another measure of structure is the compressed oil absorption number, or COAN (ASTM D3493-18), where a carbon black sample is mechanically compressed prior to performing the oil absorption measurement. The difference between OAN and COAN values can be an indicator of the stability of the carbon black structure. Grades with relatively large aggregates with a high number of primary particles can be high structure grades, with bulkier aggregates that have more void space and high oil absorption. High structure carbon black can increase compound viscosity, modulus, and conductivity. High structure can also reduce die swell, loading capacity, and improve dispersibility. Lower structure carbon blacks can decrease compound viscosity and modulus, increase elongation, die swell and loading capacity, but can also decrease dispersibility. If all other features of a carbon black are kept constant, narrow aggregate size distribution increases difficulty of carbon black dispersion and increases hysteresis and lowers resilience.

The basic method for the production of carbon black is well known. Generally, carbon black is produced by the partial oxidation or thermal decomposition of hydrocarbon gases or liquids, where a hydrocarbon raw material (hereinafter called “feedstock hydrocarbon”) is injected into a flow of hot gas wherein the feedstock hydrocarbon is pyrolyzed and converted into a smoke before being quenched by a water spray. The hot gas is produced by burning fuel in a combustion section. The hot gas flows from the combustion section into a reaction section which is in open communication with the combustion section. The feedstock hydrocarbon is introduced into the hot gas as the hot gas flows through the reaction section, thereby forming a reaction mixture comprising particles of forming carbon black. The reaction mixture flows from the reactor into a cooling section which is in open communication with the reaction section. At some location in the cooling section, one or more quench sprays of, for example, water, are introduced into the flowing reaction mixture thereby lowering the temperature of the reaction mixture below the temperature necessary for carbon black production and halting the carbon formation reaction. The black particles are then separated from the flow of hot gas. A broad range of carbon black types can be made by controlled manipulation of the reactor conditions.

Many carbon black reactors normally comprise a cylindrical combustion section axially connected to one end of a cylindrical or frusto-conical reaction section. A reaction choke is often axially connected to the other end of the reaction section. The reaction choke has a diameter substantially less than the diameter of the reaction section and connects the reaction section to the cooling section. The cooling section is normally cylindrical and has a diameter which is substantially larger than the diameter of the reaction choke.

The carbon black material of the present invention can be made using techniques generally known in the carbon black art. Various methods of making the inventive carbon black are described below and in the Examples. Variations on these methods can be determined by one of skill in the art. In one aspect, the carbon blacks of the present invention can be produced in a carbon black reactor, such as those described generally in U.S. Pat. Nos. 4,927,607 and 5,256,388, the disclosure of which are hereby incorporated by reference in their entireties. Other carbon black reactors can be used, and one of skill in the art can determine an appropriate reactor for a particular application. Feedstock, combustion feeds, and quenching materials are well known in the carbon black art. The choice of these feeds is not critical to the carbon blacks of the present invention. One of skill in the art can determine appropriate feeds for a particular application. The amounts of feedstock, combustion feeds, and quenching materials can also be determined by one of skill in the art which are suitable for a particular application.

It is well known that carbon black exists as a collection of aciniform aggregates that cover a wide range of surface area and structure or absorptive capacity. The absorptive capacity or aggregate structure manifests itself through its impact on viscosity in a polymeric compound, with higher structure driving higher viscosity. More fundamentally and from a morphological standpoint, structure manifests itself through shape and/or the degree of aggregate complexity, with lower structure aggregates having a more compact, spherical and ellipsoidal structure and higher structure aggregates having a more branched and open architecture capable of occluding a significant amount of polymer.

In one aspect, the process for preparing the polymer compound comprises: (a) providing a feed composition comprising a polymer and a filler; wherein the filler is present in the feed composition in an amount ranging from 5% to 40% by weight of the feed composition; and (b) homogenizing the feed composition to form a molten polymer composition; wherein homogenizing is carried out at a temperature that is 10° C. to 100° C. higher than the upper limit of the recommended processing temperature range of the polymer; thereby forming the polymer compound. In a further aspect, the process further comprises solidifying the molten polymer composition.

In one aspect, the methods described herein can provide a conductive polymeric compound comprising a high structure filler such as carbon black, prepared using compounding equipment running at reduced melt viscosities and short mixing times.

In another aspect, the methods described herein can be used with commercially available compounding equipment to develop a conductive compound with highly structured filler such as carbon black.

In various aspects, the compounding of conductive or high structure filler materials such as carbon blacks into plastics typically involves filler structure breakdown due to high shear stresses generated to disperse filler in the compounding process and the formation nature of filler aggregates, particularly carbon black. Retaining the filler structure in the compounding process is highly desired for conductivity performance, for example, as fillers such as carbon blacks with higher structure benefit the formation of the conductive network. The methods of the present disclosure provide a unique process that facilitates retention of all or significantly all of the filler structure so that a resulting compound can exhibit robust conductivity performance and other desirable properties at equivalent or lower loadings than those used with conventional materials or compounding methods.

In one aspect, the methods described herein can be applied to a variety of filler materials, such as conductive carbon black materials, resin systems, and to commercial continuous mixers. Conventional compounding methods comprise mixing one or more resins and one or more filler materials in a mixing device. When the filler material comprises a high structure filler, such as a high structure carbon black, the shear forces developed during compounding and/or extrusion or injection molding can result in the loss of filler structure. For example, high compounding shear forces can result in broken carbon black aggregates, and thus, lower filler structure and lower electrical conductivity values in the resulting polymeric article.

For example, the void volume (V′/V) of a carbon black material can be reduced significantly, for example, from about 3.0 to a level of about 1.6-2.0, during compounding. In the present invention, high structure carbon blacks can be compounded at elevated temperatures, as compared to conventional processing temperatures. Conventional processing of fillers and plastics teaches that high viscosities are desirable to achieve good dispersion and mixing. In the present invention, higher processing temperatures and thus, lower viscosities are utilized, contrary to conventional wisdom, to reduce the breakdown of carbon black structure, while still maintaining good dispersion.

The filler of the present invention can comprise any filler, e.g., a filler having an aciniform structure. In one aspect, the filler can comprise a carbon black material. In another aspect, the filler can comprise a conductive or semi-conductive carbon black. In yet another aspect, the filler can comprise a high structure carbon black. In another aspect, the filler can comprise a carbon black having an oil absorption number of at least about 100, 105, 110, 115, 120, 125, 130, 135, 140, 145, 150, 155, 160, 165, 170, 175, 180, 185, 190 cc/100 g, or higher, as measured according to ASTM D2414-18. In other aspects, the filler can comprise a carbon black having an oil absorption number of from about 100 to about 250, from about 100 to about 180, from about 130 to about 160, from about 125 to about 175, from about 140 to about 160, from about 140 to about 150, from about 150 to about 160, from about 100 to about 160, from about 110 to about 150, or from about 120 to about 155 cc/100 g. In various specific aspects, the carbon black can comprise Birla Carbon 7055, 7060, 7067, CONDUCTEX KU, CONDUCTEX SCU, RAVEN P, RAVEN P7U, or RAVEN PFEB carbon blacks, available from Birla Carbon, Marietta, Ga. USA. In still other aspects, the filler can comprise any other carbon black suitable for use in the present methods.

In a further aspect, the filler can be carbon black that has (a) an oil absorption number (OAN) ranging from 100 cc/100 g to 180 cc/100 g as measured according to ASTM D2414-18; (b) a nitrogen surface area (NSA) ranging from 50 m²/g to 210 m²/g as measured by ASTM D6556; and (c) a statistical thickness surface area (STSA) ranging from 50 m²/g to 150 m²/g as measured by ASTM D6556. In a further aspect, the carbon black has a mean particle size distribution ranging from 20 nm to 60 nm as measured according to ASTM D3849. In a still further aspect, the carbon black has a mean particle size distribution ranging from 40 nm to 50 nm as measured according to ASTM D3849.

In other aspects, the filler can comprise a surface modified carbon black, such as, for example, an oxidized carbon black. In a further aspect, the filler can have an aciniform structure as determined by transmission electron microscopy (TEM). In a still further aspect, the filler can comprise carbon black that is semi-conductive or conductive.

The amount of filler, e.g., carbon black, utilized in a particular polymer system can vary depending on the polymer and the desired properties of the finished article. In various aspects, the filler, e.g., carbon black, loading can be about 5 wt. %, 7 wt. %, 9 wt. %, 11 wt. %, 13 wt. %, 15 wt. %, 17 wt. %, 19 wt. %, 21 wt. %, 23 wt. %, 25 wt. %, 27 wt. %, 29 wt. %, 31 wt. %, 33 wt. %, 35 wt. %, 40 wt. %, 45 wt. %, 50 wt. %, 55 wt. %, 60 wt. %, or more. In other aspects, the filler, e.g., carbon black, loading can be from about 15 wt. % to about 60 wt. %, from about 15 wt. % to about 50 wt. %, from about 15 wt. % to about 40 wt. %, from about 15 wt. % to about 30 wt. %, from about 18 wt. % to about 30 wt. %, from about 20 wt. % to about 27 wt. %, from about 22 wt. % to about 30 wt. %, or from about 25 wt. % to about 35 wt. %. In some aspects, the filler is present in the feed composition in an amount ranging from 5% to 40% by weight of the feed composition. In further aspects, the filler is present in the feed composition in an amount ranging from 15% to 30% by weight of the feed composition. In a further aspect, the filler is present in the feed composition in an amount ranging from 18% to 27% by weight of the feed composition.

In still other aspects, the specific loading of a carbon black or other filler can vary depending on the particular polymer, carbon black, and desired properties of a finished article. In such aspects, the filler loading can be less than or greater than any particular value recited herein. In any instance wherein carbon black is referred to herein, this application should be deemed to also include references to such concentrations or loadings with any other suitable filler or combinations of fillers.

The polymer can comprise any polymer or mixture of polymers suitable for use in the present invention. In one aspect, the polymer or mixture of polymers can be melt-processable. In one aspect, the polymer can comprise a thermoplastic polymer. In another aspect, the polymer can comprise a thermoset polymer. In various aspects, the polymer can comprise an olefin, such as, for example polyethylene or polypropylene. In other aspects, the polymer can comprise an acetal, acrylic, polyamide, polystyrene, polyvinyl chloride, acrylonitrile butadiene styrene, polycarbonate, or other polymer, copolymer, or mixture thereof. In some aspects, the resulting polymer compound prepared using a disclosed process can be a conductive polymer compound, e.g., a polymer compound having a surface resistivity of about 1,000 ohm/square or less.

In one aspect, the polymer can have a melt flow index (in units of g/10 min) of about 5, 10, 15, 20, 25, 30, 35, 40, 45, 50, 55, 60, 65, 70, 75, 80, 85, 90, 95, or more. In a further aspect, the polymer has a melt flow index of at least 5 g/10 min. In a still further aspect, the polymer has a melt flow index of at least 20 g/10 min. In further aspects, the polymer has a melt flow index ranging from 10 to 90 g/10 min. Melt flow index values can be measured according to ASTM D1238.

In various specific aspects, the polymer can comprise a polypropylene, such as, for example, Ravago CERTENE PBM-20NB, having a melt flow index of 20 g/10 min, as measured according to ASTM D1238, or RAVAGO PBM-80N, having a melt flow index of 80 g/10 min as measured according to ASTM D1238. In a further aspect, the polymer can be a polypropylene such as PP1024E4 (melt flow index of 13), PP1105E1 (melt flow index of 35), or PP7905E1 (melt flow index of 100) (all available from ExonnMobil).

In other aspects, the composition can comprise other components, such as, for example, antioxidants, processing aids, oils, waxes, mold release agents, and/or other materials commonly used in the processing of polymeric materials.

In one aspect, the processing temperature utilized in mixing and/or compounding the polymeric material with the filler can be from about 10° C. to about 100° C. higher than the upper limit of the recommended processing temperature for the particular polymeric material. In various aspects, the processing temperature utilized is about 10, 15, 20, 25, 30, 35, 40, 45, 50, 55, 60, 65, 70, 75, 80, 85, 90, 95, or 100° C. higher than the upper limit of recommended processing temperature for a particular polymeric material. It should be understood that the recommended processing temperature can vary depending on the particular polymeric material, and this invention is intended to provide a method wherein the temperature utilized is greater than that typically used or recommended for a given material. One of skill in the art should be familiar with the properties and recommended processing conditions for a particular polymeric material, and thus, be able to select a higher temperature based thereon. It should be cautioned that the elevated temperatures utilized herein should be reviewed to ensure that no hazardous materials are released or evolved when operating at elevated temperatures, and that the equipment and materials can all be utilized in a safe manner at such elevated temperatures.

In some aspects, the method can further comprise obtaining the recommended processing temperature of a particular polymer, e.g., from a technical data sheet provided by the manufacturer, and determining an elevated processing temperature based on the obtained recommended processing temperature range. In a further aspect, the recommended processing temperature of an acetal polymer can be 180-210° C., and thus the processing temperature using a disclosed method can be 10° C. to 100° C. higher than the upper limit of the range. In a further aspect, the recommended processing temperature of an acrylic polymer can be 210-250° C., and thus the processing temperature using a disclosed method can be 10° C. to 100° C. higher than the upper limit of the range. In a further aspect, the recommended processing temperature of a NYLON 6 polymer can be 230-290° C., and thus the processing temperature using a disclosed method can be 10° C. to 100° C. higher than the upper limit of the range. In a further aspect, the recommended processing temperature of a NYLON 6/6 polymer can be 270-300° C., and thus the processing temperature using a disclosed method can be 10° C. to 100° C. higher than the upper limit of the range. In a further aspect, the recommended processing temperature of a polycarbonate polymer can be 280-320° C., and thus the processing temperature using a disclosed method can be 10° C. to 100° C. higher than the upper limit of the range. In a further aspect, the recommended processing temperature of a polyester polymer can be 240-275° C., and thus the processing temperature using a disclosed method can be 10° C. to 100° C. higher than the upper limit of the range. In a further aspect, the recommended processing temperature of a PET polymer (semi-crystalline or amorphous) can be 260-280° C., and thus the processing temperature using a disclosed method can be 10° C. to 100° C. higher than the upper limit of the range. In a further aspect, the recommended processing temperature of a polypropylene polymer can be 200-280° C., and thus the processing temperature using a disclosed method can be 10° C. to 100° C. higher than the upper limit of the range. In a further aspect, the recommended processing temperature of a polypropylene polymer can be 200-220° C., and thus the processing temperature using a disclosed method can be 10° C. to 100° C. higher than the upper limit of the range. In a further aspect, the recommended processing temperature of a polypropylene polymer can be 200-230° C., and thus the processing temperature using a disclosed method can be 10° C. to 100° C. higher than the upper limit of the range. In a further aspect, the recommended processing temperature of a polypropylene polymer can be 200-240° C., and thus the processing temperature using a disclosed method can be 10° C. to 100° C. higher than the upper limit of the range. In a further aspect, the recommended processing temperature of a polypropylene polymer can be 200-250° C., and thus the processing temperature using a disclosed method can be 10° C. to 100° C. higher than the upper limit of the range. In a further aspect, the recommended processing temperature of a polystyrene polymer can be 170-280° C., and thus the processing temperature using a disclosed method can be 10° C. to 100° C. higher than the upper limit of the range. In a further aspect, the recommended processing temperature of a TPE polymer can be 260-320° C., and thus the processing temperature using a disclosed method can be 10° C. to 100° C. higher than the upper limit of the range.

In a mixer such as a continuous mixer, any mixing rotors suitable for use with the present invention can be employed. In some aspects, a suitable continuous mixer can comprise a pair of counter-rotating, non-intermeshing rotors running at synchronous speed. Pairs of rotors in such continuous mixers are denominated according to a rotor style number, e.g., “style 7/15 rotor combination,” or in some cases, as a “#7/#15” rotor combination. In various aspects, a pair of rotors can comprise one of the following pairs: #7/#7, #7/#15, #15/#7, #15/#15. In other aspects, other rotors or combinations of rotors can be used.

In one aspect, a continuous mixer can be operated to compound polypropylene and Birla Carbon 7055 carbon black at a loading of from about 18 wt. % to about 27 wt. %, wherein the hopper was set at 149° C., the chamber was set at 288° C., and the orifice was set at 232° C. In such an aspect, a pair of #15 mixing rotors was employed for aggressive compounding.

In one aspect, polypropylene having a melt flow index of 80 can be used at a processing temperature of 260° C. In various aspects, the carbon black for such a mix can be Birla Carbon 7055 carbon black at a loading level of from about 18 wt. % to about 27 wt. %. In other aspects, the temperature of any particular component of a continuous mixer or compounding equipment can be set to provide the desirable performance as described herein.

The higher processing temperatures described herein can reduce viscosity of the melted polymeric material, thus reducing shear and breakdown of the filler structure.

The feed rate or throughput of a mixer can be any value suitable for processing a polymeric material as described herein. In various aspects, the throughput can be 500 kg/hr, or 500, 600, 650, 700, 750, 800, 850, 900, 950, 1000, 1050, 1100, 1150, 1200, 1250, 1300, 1350, 1400, 1450, or 1500 kg/hr. It should be understood that the feed rate can be lower than or higher than any value recited herein, and can be dependent upon the mixing equipment, polymeric material, and filler material. One of skill in the art, in possession of this disclosure, could readily determine an appropriate feed rate.

In another aspect, a mold can be held at a temperature sufficient to reduce a skin layer thickness. In one aspect, a mold can be held at a temperature of about 140° F.

Carbon black structure breakdown analyzed via transmission electron microscopy with automated image analysis (TEM/AIA) after the carbon black was extracted from the compound via pyrolysis following ASTM procedure D3849. In addition, high shear viscosities were measured with a capillary rheometer at 230° C.

In one aspect, the process for preparing the polymer compound further comprises solidifying the molten polymer composition; wherein the filler retains at least 80% of its structure after solidifying the molten polymer composition, as measured by transmission electron microscopy (TEM) according to ASTM D3849. In a further aspect, the filler retains at least 90% of its structure after solidifying the molten polymer composition, as measured by transmission electron microscopy (TEM) according to ASTM D3849. In a still further aspect, the filler retains at least 95% of its structure after solidifying the molten polymer composition, as measured by transmission electron microscopy (TEM) according to ASTM D3849. In some aspects, the molten polymer composition can be solidified into pellets of the polymer compound.

In one aspect, the filler material, such as carbon black, can retain at least about 80% of its structure after compounding, homogenizing the filler and polymer, and/or extrusion or molding of the polymer compound. In other aspects, the filler material can retain at least about 80%, at least about 85%, at least about 87%, at least about 89%, at least about 91%, at least about 92%, at least about 93%, at least about 94%, at least about 95%, at least about 96%, at least about 97%, at least about 98%, at least about 99%, or more of its structure after compounding, homogenizing the filler and polymer, and/or extrusion or molding of the polymer compound.

In still other aspects, the resulting compound can have a dispersion index of at least about 80%, at least about 82%, at least about 84%, at least about 86%, at least about 88%, at least about 90%, at least about 92%, at least about 93%, at least about 94%, at least about 95%, at least about 96%, at least about 97%, at least about 98%, at least about 99%, or more. Dispersion index can be measured according to ASTM D2663.

In still other aspects, the resulting polymer compound can have a dispersion index of at least about 80%, wherein the filler retains at least about 80% of its structure, or a dispersion index of at least about 85%, wherein the filler retains at least about 85% of its structure, or a dispersion index of at least about 90%, wherein the filler retains at least about 90% of its structure, or a dispersion index of at least about 95%, wherein the filler retains at least about 95% of its structure, or a dispersion index of at least about 80%, wherein the filler retains at least about 90% of its structure, or a dispersion index of at least about 85%, wherein the filler retains at least about 90% of its structure, or a dispersion index of at least about 90%, wherein the filler retains at least about 85% of its structure, or a dispersion index of at least about 92%, wherein the filler retains at least about 85% of its structure, or a dispersion index of at least about 95%, wherein the filler retains at least about 85% of its structure, or a dispersion index of at least about 90%, wherein the filler retains at least about 87% of its structure, or a dispersion index of at least about 94%, wherein the filler retains at least about 90% of its structure.

In one aspect, the methods described herein can be utilized on any conventional compounding or mixing equipment. In other aspects, the methods described herein can be utilized on a continuous mixer, such as, for example, a Farrel Compact Processor (FCP, example, CP550) or Farrel Continuous Mixer, available from Farrel Pomini (Ansonia, Conn. USA). A continuous mixer typically runs at lower processing temperatures as compared to recommended processing temperatures for specific plastic resins. In various aspects, the methods described herein employ atypically high processing temperatures for compounding to take advantage of the short residence time of the resin in the compounding process, while still achieving good dispersion. In such aspects, the rotor design of a particular mixer becomes less important for making compounds where high electrical conductivity is desirable.

In some aspects, the process comprises (a) providing a mixing device having a hopper and a mixing chamber; (b) supplying the feed composition comprising the polymer and the filler to a hopper of the mixing device; (c) transferring the feed composition from the hopper into the mixing chamber of the mixing device; and (d) homogenizing the feed composition within the mixing chamber to form the molten polymer composition. In a further aspect, the molten polymer composition can be solidified, e.g., into solid pellets. In some aspects, the mixing chamber of the mixing device comprises at least one co-rotating double-rotor extruder. In a further aspect, the mixing chamber of the mixing device comprises counter-rotating and non-intermeshing double rotors. In a still further aspect, the counter-rotating and non-intermeshing double rotors are selected from a style 7/7 (#7/#7) rotor combination, a style 7/15 (#7/#15) rotor combination, a style 15/7 (#15/#7) rotor combination, or a style 15/15 (#15/#15) rotor combination.

When using a Farrel Compact Processor or Continuous Mixer, one or more solid polymeric resins can be metered and fed into the mixer, along with the additive (e.g., carbon black) and other optional fillers and ingredients. The feed section typically includes a pair of short, deep-channel, short-pitched screws, whose function is the convey the solids to the mixing section. Feed screws are typically single flighted, while the mixing section will include two wings or lobes. In the transition between the feed and mixing sections, one of the two rotor wings appears as the continuation of the feed screw flight (called the fed wing), which the other rises from the root of the feed screw (called the unfed wing). In designs with two-flighted feed screws, both mixer wings are fed. Fed and unfed wings have different solids conveyance characteristics. In some aspects, a Farrel Continuous Mixer or other mixing device can have a relatively larger free volume in the mixing chamber, which can help retain the structure of the filler material.

In the mixing chamber, each rotor wing starts with a forward pumping section (helical twist opposite to the direction of rotation), followed by a reverse pumping section (helical twist in the direction of rotation), and optionally ending with a short neutral section (no helical twist). The point at which the forward and reverse pumping sections meet is called the apex of the wing. The primary function of the forward pumping section is to compact, heat up, and start the softening or melting of the solid feed. The energy required for this process is provided by the motor power, which is dissipated into thermal energy by friction between solid particles and metal walls, interparticle friction, and viscous energy dissipation in the melt-solid mixture. The mixing action of the rotors keeps the melting solid particles suspended in the molten material and prevents the formation of a compact solid bed. The melting process if completed in the reverse pumping section when the resulting melt is thoroughly mixed and homogenized. Further details on the structure and operation of the Farrel compact or continuous mixture can be found in Plastics Compounding: Equipment and Processing (1998), Chapter 9, “Farrel Continuous Mixture Systems for Plastics Compounding,” by Eduardo L. Canedo and Lefteris N. Valsamis (David B. Todd, editor) (Carl Hanser Verlag, Munich), which is incorporated by reference in its entirety for its teachings of Farrel Continuous Mixer systems.

The surface resistivity of a compounded polymeric material, prepared according to the methods as described herein, can be measured using a Loresta-GP MCP-T600 resistivity meter (ASTM D4496) on injected molded chips.

In one aspect, the methods described herein provide compounds having improved carbon black dispersion and conductivity (i.e., surface resistivity) values when compounded on a continuous mixer, as compared to conventional twin-screw extruder equipment.

Also disclosed herein are polymer compounds, e.g., conductive polymer compounds, prepared by any of the disclosed methods.

In one aspect, the surface resistivity of an injected-molded chip formed from the conductive polymer compound is 1,000 ohm/square or less as measured on a Loresta-GP MCP-T600 resistivity meter according to ASTM D4496. In a further aspect, the surface resistivity of an injected-molded chip formed from the conductive polymer compound ranges from 10 ohm/square to 1,000 ohm/square as measured on a Loresta-GP MCP-T600 resistivity meter according to ASTM D4496. In a still further aspect, the surface resistivity of an injected-molded chip formed from the conductive polymer compound ranges from 10 ohm/square to 80 ohm/square as measured on a Loresta-GP MCP-T600 resistivity meter according to ASTM D4496. In yet a further aspect, the surface resistivity of an injected-molded chip formed from the conductive polymer compound ranges from 20 ohm/square to 80 ohm/square as measured on a Loresta-GP MCP-T600 resistivity meter according to ASTM D4496.

### Exemplary Aspects

In view of the described methods, polymer compounds, and variations thereof, below are described certain more particular aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A process for preparing a polymer compound, comprising: (a) providing a feed composition comprising a polymer and a filler; wherein the filler is present in the feed composition in an amount ranging from 5% to 40% by weight of the feed composition; and (b) homogenizing the feed composition to form a molten polymer composition; wherein homogenizing is carried out at a temperature that is 10° C. to 100° C. higher than the upper limit of the recommended processing temperature range of the polymer; thereby forming the polymer compound.

Aspect 2: The process of aspect 1, further comprising solidifying the molten polymer composition; wherein the filler retains at least 80% of its structure after solidifying the molten polymer composition, as measured by transmission electron microscopy (TEM) according to ASTM D3849.

Aspect 3: The process of aspect 1 or 2, wherein the filler retains at least 90% of its structure after solidifying the molten polymer composition, as measured by transmission electron microscopy (TEM) according to ASTM D3849.

Aspect 4: The process of any preceding aspect, wherein the filler retains at least 95% of its structure after solidifying the molten polymer composition, as measured by transmission electron microscopy (TEM) according to ASTM D3849.

Aspect 5: The process of any preceding aspect, wherein the molten polymer composition is solidified into pellets of the polymer compound.

Aspect 6: The process of any preceding aspect, wherein the filler is present in the feed composition in an amount ranging from 15% to 30% by weight of the feed composition.

Aspect 7: The process of any preceding aspect, wherein the filler is present in the feed composition in an amount ranging from 18% to 27% by weight of the feed composition.

Aspect 8: The process of any preceding aspect, wherein an aggregate of the filler has an aciniform structure as determined by transmission electron microscopy (TEM).

Aspect 9: The process of any preceding aspect, wherein the filler is a carbon black.

Aspect 10: The process of aspect 9, wherein the carbon black is semi-conductive or conductive.

Aspect 11: The process of aspect 9 or 10, wherein the carbon black has an oil absorption number (OAN) of at least 100 cc/100 g as measured according to ASTM D2414-18.

Aspect 12: The process of any of aspects 9-11, wherein the carbon black has an oil absorption number (OAN) ranging from 100 cc/100 g to 250 cc/100 g as measured according to ASTM D2414-18.

Aspect 13: The process of any of aspects 9-12, wherein the carbon black has an oil absorption number (OAN) ranging from 100 cc/100 g to 180 cc/100 g as measured according to ASTM D2414-18.

Aspect 14: The process of any of aspects 9-13, wherein the carbon black has (a) an oil absorption number (OAN) ranging from 100 cc/100 g to 180 cc/100 g as measured according to ASTM D2414-18; (b) a nitrogen surface area (NSA) ranging from 50 m²/g to 210 m²/g as measured by ASTM D6556; and (c) a statistical thickness surface area (STSA) ranging from 50 m²/g to 150 m²/g as measured by ASTM D6556.

Aspect 15: The process of any of aspects 9-14, wherein the carbon black has a mean particle size distribution ranging from 20 nm to 60 nm as measured according to ASTM D3849.

Aspect 16: The process of any of aspects 9-15, wherein the carbon black has a mean particle size distribution ranging from 40 nm to 50 nm as measured according to ASTM D3849.

Aspect 17: The process of any preceding aspect, wherein the polymer is a melt-processable polymer, a thermoplastic, or a thermoset.

Aspect 18: The process of any preceding aspect, wherein the polymer is a poly(olefin), a polyethylene, a polypropylene, an acetal, an acrylic, a polyamide, a polystyrene, a polyvinyl chloride, an acrylonitrile butadiene styrene, a polycarbonate, or a copolymer or mixture thereof.

Aspect 19: The process of any preceding aspect, wherein the polymer has a melt flow index of at least 5 g/10 min as measured according to ASTM D1238.

Aspect 20: The process of any preceding aspect, wherein the polymer has a melt flow index of at least 20 g/10 min as measured according to ASTM D1238.

Aspect 21: The process of any preceding aspect, wherein the polymer has a melt flow index ranging from 10 g/10 min to 90 g/10 min as measured according to ASTM D1238.

Aspect 22: The process of any preceding aspect, wherein the polymer compound is a conductive polymer compound.

Aspect 23: The process of aspect 22, wherein the surface resistivity of an injected-molded chip formed from the conductive polymer compound is 1,000 ohm/square or less as measured on a Loresta-GP MCP-T600 resistivity meter according to ASTM D4496.

Aspect 24: The process of aspect 22 or 23, wherein the surface resistivity of an injected-molded chip formed from the conductive polymer compound ranges from 10 ohm/square to 1,000 ohm/square as measured on a Loresta-GP MCP-T600 resistivity meter according to ASTM D4496.

Aspect 25: The process of any of aspects 21-24, wherein the surface resistivity of an injected-molded chip formed from the conductive polymer compound ranges from 10 ohm/square to 80 ohm/square as measured on a Loresta-GP MCP-T600 resistivity meter according to ASTM D4496.

Aspect 26: The process of any of aspects 21-25, wherein the surface resistivity of an injected-molded chip formed from the conductive polymer compound ranges from 20 ohm/square to 80 ohm/square as measured on a Loresta-GP MCP-T600 resistivity meter according to ASTM D4496.

Aspect 27: The process of any preceding aspect, wherein the polymer compound has a dispersion index of at least 80 as measured according to ASTM D2663.

Aspect 28: The process of any preceding aspect, wherein the polymer compound has a dispersion index of at least 90 as measured according to ASTM D2663.

Aspect 29: The process of any preceding aspect, wherein the polymer compound has a dispersion index of at least 95 as measured according to ASTM D2663.

Aspect 30: The process of any preceding aspect, wherein the process comprises: (a) providing a mixing device having a hopper and a mixing chamber; (b) supplying the feed composition comprising the polymer and the filler to a hopper of the mixing device; (c) transferring the feed composition from the hopper into the mixing chamber of the mixing device; and (d) homogenizing the feed composition within the mixing chamber to form the molten polymer composition.

Aspect 31: The process of aspect 30, wherein the mixing chamber of the mixing device comprises at least one co-rotating double-rotor extruder.

Aspect 32: The process of aspect 30 or 31, wherein the mixing chamber of the mixing device comprises counter-rotating and non-intermeshing double rotors.

Aspect 33: The process of aspect 32, wherein the counter-rotating and non-intermeshing double rotors are selected from a style 7/7 (#7/#7) rotor combination, a style 7/15 (#7/#15) rotor combination, a style 15/7 (#15/#7) rotor combination, or a style 15/15 (#15/#15) rotor combination.

Aspect 34: The process of any of aspects 30-33, wherein the feed composition is supplied to the hopper of the extruder device at a rate of least 500 kg/hr.

Aspect 35: A conductive polymer compound prepared by the method of any preceding aspect.

### Examples

Various exemplary embodiments of the invention are detailed below. These embodiments are intended to be exemplary and are not intended to limit the scope of the invention. For each of the following examples, unless indicated to the contrary, the following processes, equipment, and conditions were utilized.

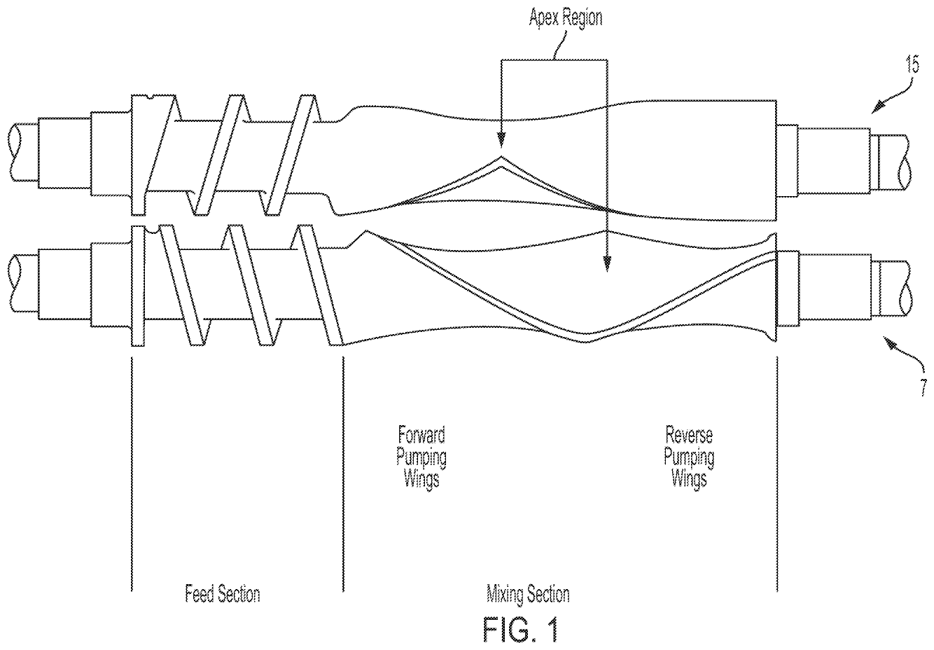

Materials were compounded on a Farrel CP550 mixer with a throughput of about 500 kg/hr and using two types of rotors (#15 and #7). See FIG. 1; see also Plastics Compounding: Equipment and Processing (1998), Chapter 9, “Farrel Continuous Mixture Systems for Plastics Compounding,” by Eduardo L. Canedo and Lefteris N. Valsamis (David B. Todd, editor) (Carl Hanser Verlag, Munich).

A polypropylene resin having a melt flow index of 80, and Birla Carbon 7055 carbon black were used for a compound to be injection molded. Higher processing temperatures (˜260° C.) were used to minimize the carbon black structure breakdown.

Compounds with target carbon black loadings ranging from 27% to 18% were prepared. Table 1 summarizes morphological analysis results of the carbon black CONDUCTEX 7055 ULTRA extracted from the compound samples using rotors (#15/#15). These samples also had distinctly high levels of carbon black structure retention in comparison with historical data.

### Particle Size Distributional Properties (Procedure ASTM D3849)*

| | | Mag. | Mean | SD | WM | HI | EMSA |
|---|---|---|---|---|---|---|---|
| | | Units | | | | | |
| Sample | Description | — | nm | nm | nm | — | m²/g |
| 1 | Compound with | 1500X | 44.1 | 17.2 | 64.0 | 1.5 | 56 |
| | 27% carbon black | | | | | | |
| | loading | | | | | | |
| 2 | Compound with | 1500X | 49.0 | 19.2 | 70.6 | 1.4 | 51 |
| | 25% carbon black | | | | | | |
| | loading | | | | | | |
| 3 | Compound with | 1500X | 45.2 | 18.2 | 66.1 | 1.5 | 54 |
| | 24% carbon black | | | | | | |
| | loading | | | | | | |
| 4 | Compound with | 1500X | 49.1 | 18.8 | 70.4 | 1.4 | 51 |
| | 23% carbon black | | | | | | |
| | loading | | | | | | |

* Particle size distributional properties for carbon blacks of significant structure that have not been broken down via CAB mixing can overestimate the fineness of the carbon black, i.e., make it appear somewhat finer (higher specific surface area, smaller mean particle size) than it actually is. Therefore, these properties are regarded on a comparative basis.

### Aggregate Size Distributional Properties (Procedure ASTM D3849)

| | | Mag. | Mean | SD | WM | HI | V′/V |
|---|---|---|---|---|---|---|---|
| | | Units | | | | | |
| Sample | Description | — | nm | nm | nm | — | — |
| 1 | Compound with | 1500X | 216 | 121 | 409 | 1.9 | 2.5 |
| | 27% carbon black | | | | | | |
| | loading | | | | | | |
| 2 | Compound with | 1500X | 255 | 135 | 454 | 1.8 | 2.5 |
| | 25% carbon black | | | | | | |
| | loading | | | | | | |
| 3 | Compound with | 1500X | 216 | 133 | 462 | 2.1 | 2.8 |
| | 24% carbon black | | | | | | |
| | loading | | | | | | |
| 4 | Compound with | 1500X | 252 | 144 | 484 | 1.9 | 2.8 |
| | 23% carbon black | | | | | | |
| | loading | | | | | | |

M = Mean,
HI = Heterogeneity Index,
SD = Standard Deviation,
WM = Weight Mean
EMSA = Electron Microscope Surface Area,
V′/V = Structure Indicator

### Surface Resistivity Data.

| | | Surface Resistivity |
|---|---|---|
| | | of Injection |
| | | Molded Chips, |
| Sample | Description | ohm/square |
| 1 | Compound with 27% carbon black loading | 21.3 |
| 2 | Compound with 25% carbon black loading | 23.6 |
| 3 | Compound with 24% carbon black loading | 43.2 |
| 4 | Compound with 23% carbon black loading | 77.5 |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A process for preparing a polymer compound, comprising:
a) providing a feed composition comprising a polymer and a filler; wherein the filler is present in the feed composition in an amount ranging from 5% to 40% by weight of the feed composition;
b) homogenizing the feed composition to form a molten polymer composition; wherein homogenizing is carried out at a temperature that is 10° C. to 100° C. higher than the upper limit of the recommended processing temperature range of the polymer; thereby forming the polymer compound.

2. The process of claim 1, further comprising solidifying the molten polymer composition; wherein the filler retains at least 80% of its structure after solidifying the molten polymer composition, as measured by transmission electron microscopy (TEM) according to ASTM D3849.

3. The process of claim 2, wherein the filler retains at least 90% of its structure after solidifying the molten polymer composition, as measured by transmission electron microscopy (TEM) according to ASTM D3849.

4. The process of claim 2, wherein the filler retains at least 95% of its structure after solidifying the molten polymer composition, as measured by transmission electron microscopy (TEM) according to ASTM D3849.

5. The process of claim 2, wherein the molten polymer composition is solidified into pellets of the polymer compound.

6. The process of claim 1, wherein the filler is present in the feed composition in an amount ranging from 15% to 30% by weight of the feed composition.

7. The process of claim 1, wherein the filler is present in the feed composition in an amount ranging from 18% to 27% by weight of the feed composition.

8. The process of claim 1, wherein an aggregate of the filler has an aciniform structure as determined by transmission electron microscopy (TEM).

9. The process of claim 1, wherein the filler is a carbon black.

10. The process of claim 9, wherein the carbon black is semi-conductive or conductive.

11. The process of claim 9, wherein the carbon black has an oil absorption number (OAN) of at least 100 cc/100 g as measured according to ASTM D2414-18.

12. The process of claim 9, wherein the carbon black has an oil absorption number (OAN) ranging from 100 cc/100 g to 250 cc/100 g as measured according to ASTM D2414-18.

13. The process of claim 9, wherein the carbon black has an oil absorption number (OAN) ranging from 100 cc/100 g to 180 cc/100 g as measured according to ASTM D2414-18.

14. The process of claim 9, wherein the carbon black has (a) an oil absorption number (OAN) ranging from 100 cc/100 g to 180 cc/100 g as measured according to ASTM D2414-18; (b) a nitrogen surface area (NSA) ranging from 50 m2/g to 210 m2/g as measured by ASTM D6556; and (c) a statistical thickness surface area (STSA) ranging from 50 m2/g to 150 m2/g as measured by ASTM D6556.

15. The process of claim 9, wherein the carbon black has a mean particle size distribution ranging from 20 nm to 60 nm as measured according to ASTM D3849.

16. The process of claim 9, wherein the carbon black has a mean particle size distribution ranging from 40 nm to 50 nm as measured according to ASTM D3849.

17. The process of claim 1, wherein the polymer is a melt-processable polymer, a thermoplastic, or a thermoset.

18. The process of claim 1, wherein the polymer is a poly(olefin), a polyethylene, a polypropylene, an acetal, an acrylic, a polyamide, a polystyrene, a polyvinyl chloride, an acrylonitrile butadiene styrene, a polycarbonate, or a copolymer or mixture thereof.

19. The process of claim 1, wherein the polymer has a melt flow index of at least 5 g/10 min as measured according to ASTM D1238.

20. The process of claim 1, wherein the polymer has a melt flow index of at least 20 g/10 min as measured according to ASTM D1238.

21. The process of claim 1, wherein the polymer has a melt flow index ranging from 10 g/10 min to 90 g/10 min as measured according to ASTM D1238.

22. The process of claim 1, wherein the polymer compound is a conductive polymer compound.

23. The process of claim 22, wherein the surface resistivity of an injected-molded chip formed from the conductive polymer compound is 1,000 ohm/square or less as measured on a Loresta-GP MCP-T600 resistivity meter according to ASTM D4496.

24. The process of claim 22, wherein the surface resistivity of an injected-molded chip formed from the conductive polymer compound ranges from 10 ohm/square to 1,000 ohm/square as measured on a Loresta-GP MCP-T600 resistivity meter according to ASTM D4496.

25. The process of claim 22, wherein the surface resistivity of an injected-molded chip formed from the conductive polymer compound ranges from 10 ohm/square to 80 ohm/square as measured on a Loresta-GP MCP-T600 resistivity meter according to ASTM D4496.

26-35. (canceled)
